(19) United States
(12) Patent Application Publication
(10) Pub. No.: US 2015/0006148 A1
(43) Pub. Date: Jan. 1, 2015

(54) Automatically Creating Training Data For Language Identifiers

(71) Applicant: Microsoft Corporation, Redmond, WA (US)

(72) Inventors: Moises Goldszmit, Palo Alto, CA (US); Marc Najork, Palo Alto, CA (US); Stelios Paparizos, San Jose, CA (US)

(21) Appl. No.: 13/943,788

(22) Filed: Jul. 17, 2013

Related U.S. Application Data
(60) Provisional application No. 61/839,925, filed on Jun. 27, 2013.

(51) Int. Cl. G06F 17/28

(52) U.S. Cl. CPC G06F 17/28
USPC 704/8

(57) ABSTRACT

Example apparatus and methods concern automatically creating labeled training data for automatic language identifiers. One embodiment includes logic to produce a predicted language classification for a post from geographic data associated with the post. The post may be associated with a micro-blog, a social media site, or other electronic communication service that traffics in short messages having frequent colloquialisms, non-standard spelling, emoticons, and unique usages of characters to convey meaning. The embodiment includes logic to produce an actual language classification for the post using a base language classifier. The embodiment includes logic to selectively add the post and a language label for the post to an automatically generated labeled training data upon determining that the predicted language classification matches the actual language classification. The automatically generated labeled training data may then be used to build target language models, which may include a target language classifier.

### CROSS REFERENCE TO RELATED APPLICATIONS

This application claims the benefit of U.S. Provisional Application 61/839,925 filed Jun. 27, 2013.

### BACKGROUND

There are differences between languages. For example, there are differences between English and French. Trained humans fluent in either English or French are generally able to identify documents written in English or French. Automated language identifiers have been programmed to automatically identify the language in which a document is written. These automated language identifiers have performed with varying degrees of accuracy. Conventionally, an automated language identifier relied on a language model (e.g., language profile) when identifying a document. The language model conventionally has been built from a large body of labeled documents that are known to be written in the language for which the model is being built. The large body of documents may be referred to as a corpus. As used herein, the term “corpus” is used in its linguistic field usage, meaning a large and structured set of documents. This conventional approach generally relies on humans first identifying and labeling the documents for the corpus. This approach may be expensive, may be unable to adapt to changes in language usage, may be prone to human error, and may have other shortcomings.

Languages may be changing more quickly than before the advent of ubiquitous electronic connectivity and mobile devices. Additionally, interactions between persons speaking different languages may be growing more quickly than before ubiquitous electronic connectivity via mobile devices was approached. Not only are there more communications between speakers of different languages, but there are more vehicles through which communications are made. For example, social media sites, micro-blogs, emails, and other communication media may have different language usages and patterns than traditional written communications. Conventional techniques may be less accurate in this new environment where there is continued exponential growth in the amounts of user-generated content to web forums, social media sites, instant messaging applications, micro-blogs, and other applications.

Consider that some micro-blogs (e.g., Twitter) have emerged as central, global platforms on which hundreds of millions of people communicate regularly. These micro-blogs may carry enormous numbers of shorts messages, sometimes just single characters. For example, one micro-blogging service reports experiencing approximately 400 million posts per day. Performing language identification on “documents” that are presented via these micro-blog or other platforms may face challenges including informal writing styles, short message lengths, multiple languages appearing in a single message, non-language specific content (e.g., an emoticon), unconventional or non-existent punctuation, non-standard spelling for emphasis, vernacular, colloquialisms, the creation of new words (e.g., hash tags), or other issues.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods perform a two-step approach to achieve improved results when identifying the language in a modern message like a tweet, a short blog post, an instant message, a social media post, or other micro-communication that may be replete with vernacular, odd punctuation or spelling, or other features that may confound traditional single-step approaches. Example apparatus and methods first build an up-to-date base corpus from user-generated content available from, for example, online encyclopedias, newspapers, blogs, or other sources from which labeled content can be acquired. The base corpus is used to produce the base language model. The base language model may include a base language identifier. The base language identifier is used to classify target communications from a target corpus. The target corpus includes documents that include additional information from which a classification prediction can be made. The additional information may include, for example, geographic information, user-provided metadata (e.g., language preference, zip code), platform information (e.g., country code), user profile data, or other information. If the base language identifier produces a classification that matches the classification predicted from the additional information, then the document can be labeled and added to a new target training data set. The target training data set is then used to produce a set of target language models. The target language models may include a target language identifier that is configured to classify target communications. While an identifier or classifier may be discussed separately from a language model, the identifier or classifier may be part of the model. Example apparatus may dynamically and repeatedly build additional or different target training data sets from which additional or different target language models can be built, which in turn may be used to produce additional or different target language identifiers.

In one example, an appropriately labeled large dataset may be acquired as a base corpus. The base corpus can be processed to produce a set of language models. The language models may be, for example, language profiles used by statistical classifiers. Other language models may be used. The large dataset may be taken, for example, from labeled user-generated content. A target corpus may also be acquired. For example, communications from a target platform may be monitored for a period of time and communications that include supporting evidence for a language prediction may be collected. The base language models are used to classify the languages of the target corpus samples. If the language that was assigned to a sample by the classification coincides with the language indicated by the supporting evidence, then the labeled sample from the target corpus is added to a new training corpus. The new training corpus may be referred to as a “filtered language corpus.” The filtered language corpus may then be used to train models for classifying target communications.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example processing and data flow associated with automatically creating training data for automated language identifiers.

FIG. 2 illustrates a portion of an example method associated with automatically creating training data for automated language identifiers.

FIG. 3 illustrates a portion of an example method associated with automatically creating training data for automated language identifiers.

FIG. 4 illustrates an example processing and data flow associated with automatically creating training data for automated language identifiers.

FIG. 5 illustrates an example apparatus associated with automatically creating training data for automated language identifiers.

FIG. 6 illustrates an example apparatus associated with automatically creating training data for automated language identifiers.

FIG. 7 illustrates an example cloud operating environment.

FIG. 8 is a system diagram depicting an exemplary mobile communication device configured to participate in automatically creating training data for automated language identifiers.

### DETAILED DESCRIPTION

Language identification in the uber-connected micro-communication environment faces new challenges. Established models and techniques for language identification rely on a sizable corpus of labeled data for languages for which identifications are desired. This labeled data has traditionally come from curated collections of text, such as legal texts or newspaper archives. However, as noted above, language usage has changed in the era of user-generated content communicated via ubiquitous connectivity and computing. Example apparatus and methods recognize that user-generated content may provide information from which modern language models may be built. For example, an online encyclopedia to which users are able to contribute content may provide documents whose language is known and from which an initial training set can be built. The initial training set may be used to produce an initial language model that includes an initial language identifier. Once the initial language identifier is available, “documents” from a new environment (e.g., Tweets, blog posts, instant messages) may be acquired. Some of these documents may include additional information from which a prediction of the language in which the documents are written can be made. For example, a micro-post may include precise or approximate location data. A document for which sufficient additional information for making a language prediction is available may be presented to the initial language identifier. If the language identified by the initial language identifier matches the language predicted by the additional information, then the document may be labeled with the identified language and added to a separate training set. The separate training set may then be used to produce a subsequent language model having a subsequent language identifier.

Thus, in one embodiment, high quality language identification for short colloquial postings (e.g., tweets on Twitter) may be provided. In one embodiment, high quality language identification may be provided for applications where language usage defies conventions, includes vernacular or colloquialisms, includes non-traditional and language agnostic symbols (e.g., emoticons), for languages that evolve relatively quickly. Language evolution may be event driven. For example, in Twitter, as events occur, new hash tags are produced. These new hash tags may be relevant to token frequency based classifiers. Hash tag frequency may vary widely with sudden bursts of activity followed by a rapid diminution in usage. Therefore, example apparatus and methods may build models that include identifiers at times including periodically (e.g., hourly, daily, monthly), when directed by an observer, upon the occurrence of an event (e.g., hash tag trending over a threshold), continuously, or at other times. While example apparatus and methods are described in the context of posts to social media or micro-blogs, in one embodiment, more generally the example apparatus and methods concern classifying messages in languages that incorporate new words that may not be found in a standard dictionary for the language. Example apparatus and methods facilitate learning the new words and associating their character sequences with an appropriate language.

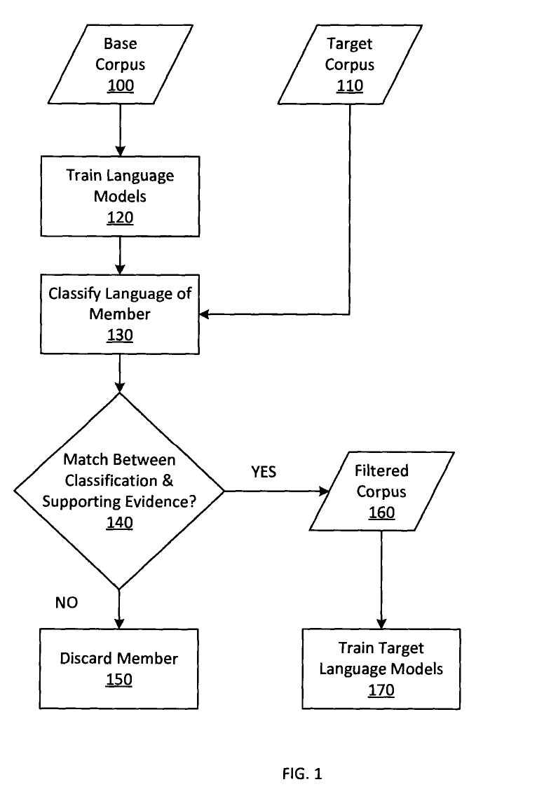

FIG. 1 illustrates an example processing and data flow associated with automatically creating training data for language identifiers. The processing and data flow illustrates one approach to providing automated and unsupervised labeled data generation for short postings that may include colloquialisms. A colloquialism may be a word, phrase, or collection of characters (e.g., OMG) that are used in conversational, informal, social networking, micro-blogging or other language but not in formal speech or writing. Colloquialisms may include words like “gonna” or “wanna”, may include phrases (e.g., “kick the bucket”), may include collections of characters (e.g., OMG, LOL), or may include other unusual collections of characters. Colloquialisms may provide clues to the language of a post because colloquialisms may be specific to a geographical region and language.

The processing and data flow illustrated in FIG. 1 includes using secondary information (e.g., metadata) available for a posting to make a prediction about a language in which the post is written and using a base language model to make an actual classification of the language in which the post is written. Consider that automatic language identification is a classification task that includes finding a mapping from a document to a language in which the document is written. Unlike conventional systems where documents are lengthy texts that are carefully prepared and edited, a “document” may include a tweet, a blog posting, a social media post, or other communication. Statistical classifiers may model both languages and documents using token frequencies. Statistical classifiers process a corpus of documents whose languages are already known. The statistical classifiers extract tokens from documents, compile token frequencies, and use the token frequencies generated by analyzing the corpus to produce a language model. The language model may be, for example, a language profile. A document to be classified may similarly have its token frequencies produced and then be represented by a document profile. Classification may involve computing a similarity score between a document profile and language profiles. The language identified for the document may be the language whose language profile most closely matched the document profile. Other language identifiers may operate in different ways but may still rely on labeled data.

FIG. 1 illustrates a base corpus 100 and a target corpus 110. The base corpus 100 may have been generated from a publicly available online source (e.g., Wikipedia) that includes labeled documents having user-generated content. The target corpus 110 may have been collected from the target communication service (e.g., Facebook, Twitter). The base corpus 100 may be used to train language models 120. The language models 120 may then be used at 130 to classify the language of a member of the target corpus 110. Recall that a prediction for the language of the member of the target corpus 110 may be made from data other than the message sent in the post. For example, a Tweet may have a country code in its meta-data from which a language prediction may be made. At 140, the classification produced at 130 and the prediction made for the member are compared. If the classification and prediction do not match, the member of the target corpus 110 may be discarded at 150. But if the classification and prediction do match, then the member of the target corpus 110 may be labeled and provided to a filtered corpus 160. The filtered corpus 160 is a corpus of documents from the target corpus 110 that have passed the matching test at 140 and that have had a label associated with them. The filtered corpus 160 can be used to train new language models, for example target language models 170.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

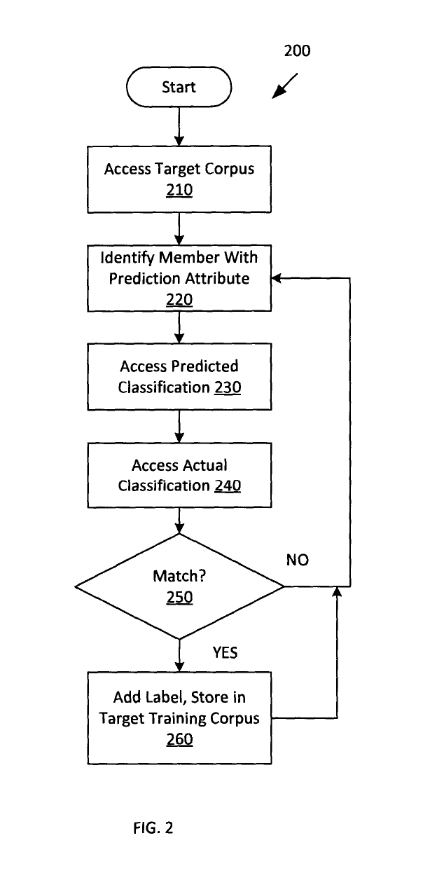

FIG. 2 illustrates an example method 200 associated with automatically creating training data for automated language identifiers. Method 200 may include, at 210, accessing a target corpus of electronic communications associated with an electronic communication service. In one embodiment, the electronic communication service is an online social networking service (e.g., Facebook) or micro-blogging service (e.g., Twitter). Other electronic communication services may be supported. The electronic communication services may be characterized by short messages that include colloquialisms, emoticons, repeating characters that have meaning, contractions (e.g., LOL, OMG), the use of multiple languages in a single message, non-standard spellings, and other attributes. The communications in the target corpus may be shorter than a threshold length (e.g., one hundred and forty characters, one hundred characters, seventy characters).

Method 200 may also include, at 220, identifying a member of the target corpus that includes an attribute from which a predicted classification of the member can be made. The attribute is a separate piece of data associated with the member. For example, the attribute is separate from a message portion of the member. The attribute may be, for example, geographic data. The geographic data may be precise (e.g., accurate to within a meter) or may be less precise (e.g., accurate to a city block, a city, a state, a region, a country). The geographic data may be, for example, a country code in metadata associated with a tweet, a GPS co-ordinate provided from a mobile device from which the message was sent, a latitude/longitude identifier, the geo-location of an IP address, or other geographic information.

Method 200 may also include, at 230, accessing the predicted classification of the member. The predicted classification is a function of the attribute. The predicted classification is made without reference to a base classifier. Method 200 may also include, at 240, accessing an actual classification of the member. The actual classification is made by the base classifier. In one embodiment, the base classifier is a statistical language classifier that relies on base language models built from a base corpus of labeled documents.

Accessing the predicted classification at 230 may include receiving a signal from a classification predictor, reading a value from a variable, reading a memory location, receiving a value in an electronic communication, or other action. Similarly, accessing the actual classification at 240 may include receiving a signal from the base classifier, reading a value from a variable, reading a memory location, receiving a value in an electronic communication, or other action.

In one embodiment, the predicted classification and the actual classification concern a language in which the member is written. For example, the predicted classification and the actual classification may identify the member as being written in English, French, German, Finnish, or some other language. In another embodiment, the predicted classification and the actual classification concern a demographic associated with a writer of the member. In different embodiments, the demographic may be, for example, age, gender, profession, social status, economic status, political leaning, sentiment towards a topic, or other demographic. For example, the predicted classification and the actual classification may identify the member as likely being written by a man over the age of fifty.

Method 200 may also include, at 250 making a determination of whether the actual classification matches the predicted classification. If the determination at 250 is no, then processing may return to 220. If the determination at 250 is yes, that the predicted classification matches the actual classification, then processing may continue at 260.

Method 200 may include, at 260, adding a labeled member to a target training corpus stored in a data store. The labeled member that is added to the target training corpus at 260 may include the member and the actual classification. Method 200 may be configured to produce a target training corpus that is sufficient for training a target classifier from the target training corpus. The target classifier will be configured to classify communications associated with the electronic communication service.

In one embodiment, method 200 may include actions that occur before action 210. These actions may be associated with preparing the base classifier. For example, method 200 may include building the base corpus of labeled documents from a publicly available online source that includes labeled user-generated content. For example, documents may be taken from online newspapers from the capitals of certain countries, from transcripts of television shows broadcast from certain cities, from well-known blogs that are known to be written in a certain language, or other labeled sources.

In one embodiment, the base classifier may be configured to classify electronic communications from the electronic communication service to within a desired accuracy, if possible. For example, the base classifier may not be employed until an accuracy of at least ninety percent is achieved. The base classifier may be configured to identify different numbers of languages.

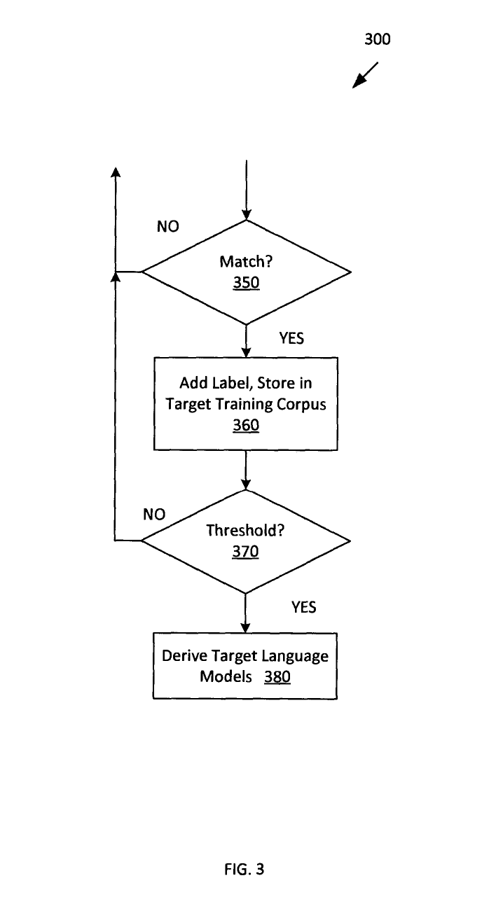

FIG. 3 illustrates a portion 300 of an example method associated with automatically creating training data for automated language identifiers. Portion 300 may pick up at action 350, which is similar to action 250 (FIG. 2), where a determination is made concerning whether a predicted classification (e.g., language, demographic) matches an actual classification. If the classifications do not match, portion 300 may return to select and process another member of the target corpus. But if the classifications match, then portion 300 may proceed at 360 to update the target training corpus with the member just processed and its label.

Portion 300 may include, at 370, determining whether the target training corpus has reached a threshold. The threshold may control whether the target training corpus is sufficient to train a target language classifier. If the threshold has not been met, then portion 300 may return to select and process another member of the target corpus. But if the threshold has been met, then processing may continue at 380.

Portion 300 may include, at 380, deriving a target language model or models using the target training corpus. Deriving the target language model or models may include, for example, extracting tokens, identifying token frequency, and producing a language profile. Other derivations may be performed for other types of language classifiers. Once the target language model or models are created, they may be stored in a data store. Deriving the target training language model may include training a target classifier. The target classifier may be trained as part of deriving the target language model or models at 380. The target classifier may be stored in a data store as part of the target training language model. Once the target classifier is available in the target training language model, the target classifier may be used to classify an electronic communication associated with the electronic communication service.

Languages may not be static entities and thus language identification may be a dynamic process. Being dynamic in a manner that facilitates adapting to language changes or social media or other communication changes may include selectively updating the target training corpus or the target training models. In different embodiments, the updating may occur upon detecting an update event including a change in a language in which communications can be written in the electronic communication service, the appearance of a new hash tag in a language in which communications can be written in the electronic communication service, or other event. In other embodiments, the updating may occur upon the passage of a threshold amount of time, upon the processing of a threshold number of members of the target corpus, or upon the occurrence of other criteria.

While FIGS. 2 and 3 illustrates various actions occurring in serial, it is to be appreciated that various actions illustrated in FIGS. 2 and 3 could occur substantially in parallel. By way of illustration, a first process could manage base corpus creation, a second process could manage target language classification, a third process could manage classification matching, and a fourth process could manage updating a training corpus and then training a target classifier from the training corpus. While four processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 200 or 300. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

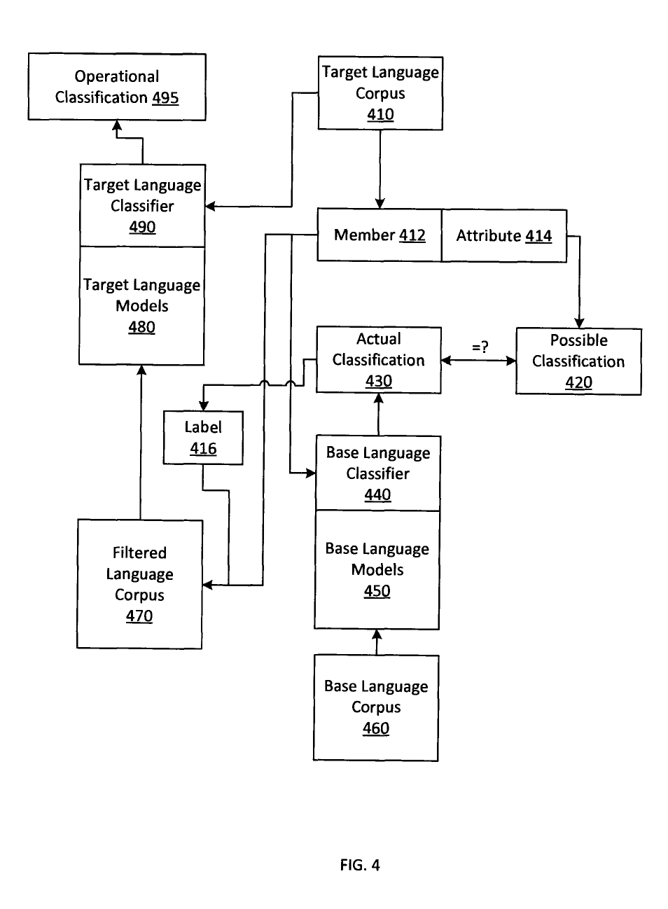

In one embodiment, a computer-readable storage medium may store computer-executable instructions that when executed by a computer control the computer to perform a method. A process and workflow for this method is illustrated in FIG. 4. The method may include constructing a base language corpus 460 from a publicly available source of labeled documents (e.g., Wikipedia) that include user-generated content. Having user-generated content may make it more likely that colloquialisms, contractions (e.g., LOL, OMG), and other unusual combinations of characters that are entering or have entered the language will be present, which may in turn improve language classification in short messages.

The method may also include deriving base language models 450 for a pre-determined number (e.g., at least ten) of languages from the base language corpus 460. The base language model 450 may include a base language classifier 440 to be able to identify documents from a communication service in the pre-determined number of languages. The base language classifier 440 may be trained until a training termination threshold is met. The threshold may be, for example, achieving a desired accuracy (e.g., ninety percent accuracy), processing a certain number of messages, iterating through a training loop a desired number of times, determining that accuracy convergence is below a desired rate, or other conditions. The base language classifier 440 will be trained from the base language corpus 460.

The method may also include identifying a possible classification 420 of a member 412 (e.g., document) in a target language corpus 410. The target language corpus 410 includes documents from the communication service. The possible classification 420 is a function of supporting evidence (e.g., geographic data) associated with the member 412. The possible classification 420 does not rely on the base language classifier 440 but rather relies on an attribute 414 associated with the member 412.

The method may also include producing an actual classification 430 of the member 412. The actual classification 430 does rely on the base language classifier 440. The actual classification 430 and the possible classification 420 may be compared to determine whether they match. Upon determining that the actual classification 430 does not match the possible classification 420, the member 412 may be discarded. But if the actual classification 430 and the possible classification 420 match, then the member 412 and a label 416 associated with the member 412 may be added to a filtered language corpus 470.

The method may also include, upon determining that the filtered language corpus 470 has reached a threshold size, deriving target language models 480 for the pre-determined number of languages from the filtered language corpus 470 or for a smaller number of languages. The target language models 480 may include a target language classifier 490 that is configured to be able to identify documents from the target language corpus 410. The target language classifier 490 may be configured to identify documents in the pre-determined number of languages to a desired accuracy. The accuracy of the target language classifier 490 may exceed that of the base classifier 440. Once the target language classifier 490 is trained to a desired point, the target language classifier 490 may be used to produce an operational classification 495 for a document from the target language corpus 410.

In one embodiment, the method may be iterated through until a threshold accuracy or other termination condition for the target language classifier 490 is achieved. Iterating through the method may include establishing the base language classifier 440 for an iteration I+1 as the target language classifier 490 of iteration I, I being an integer greater than zero. Iterating through the method may also include establishing the base language corpus 460 for iteration I+1 as the filtered language corpus 470 of iteration I. Iterating through the method may also include rebuilding a filtered language corpus 470 for iteration I+1, and rebuilding the target language classifier 490 for iteration I+1.

“Computer-readable storage medium”, as used herein, refers to a medium that stores instructions or data. “Computer-readable storage medium” does not refer to propagated signals, per se. A computer-readable storage medium may take forms, including, but not limited to, non-volatile media, and volatile media. Non-volatile media may include, for example, optical disks, magnetic disks, tapes, flash memory, ROM, and other media. Volatile media may include, for example, semiconductor memories, dynamic memory (e.g., dynamic random access memory (DRAM), synchronous dynamic random access memory (SDRAM), double data rate synchronous dynamic random-access memory (DDR SDRAM), etc.), and other media. Common forms of a computer-readable storage medium may include, but are not limited to, a floppy disk, a flexible disk, a hard disk, a magnetic tape, other magnetic medium, a compact disk (CD), other optical medium, a random access memory (RAM), a read only memory (ROM), a memory chip or card, a memory stick, and other media from which a computer, a processor or other electronic device can read.

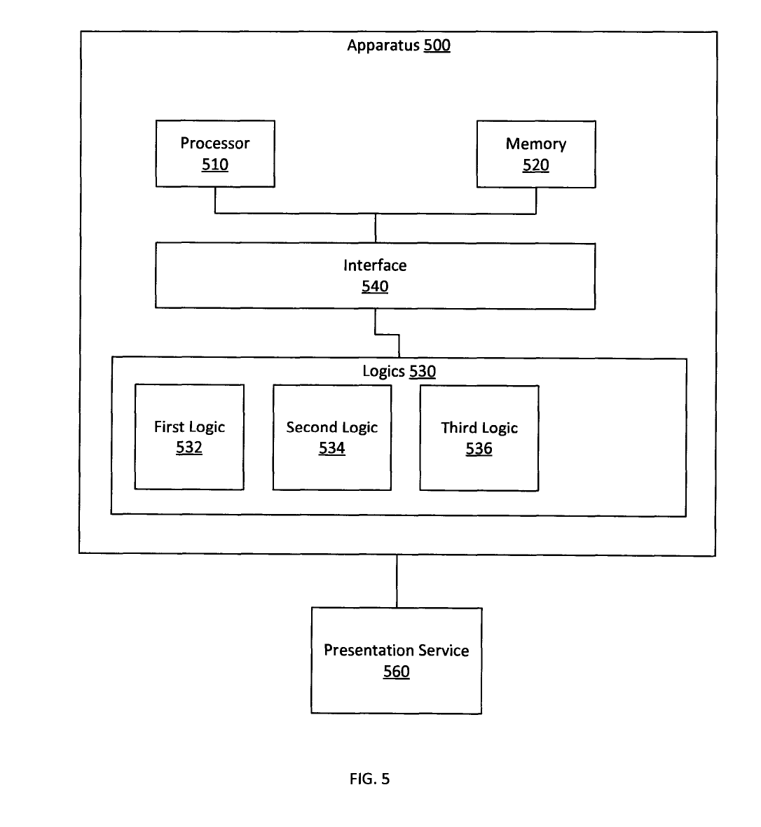

FIG. 5 illustrates an apparatus 500 that includes a processor 510, a memory 520, a set 530 of logics, and an interface 540 that connects the processor 510, the memory 520, and the set 530 of logics. The processor 510 may be, for example, a microprocessor in a computer, a specially designed circuit, a field-programmable gate array (FPGA), an application specific integrated circuit, a processor in a mobile device, a system-on-a-chip, a dual or quad processor, or other computer hardware. The set 530 of logics may be configured to bootstrap language identifiers for producing training data. Apparatus 500 may be, for example, a computer, a laptop computer, a tablet computer, a personal electronic device, a smart phone, a system-on-a-chip (SoC), or other device that can access and process data.

In one embodiment, the apparatus 500 may be a general purpose computer that has been transformed into a special purpose computer through the inclusion of the set 530 of logics. The set 530 of logics may be configured to produce labeled training data. More specifically, the set 530 of logics may be configured to automatically produce and store, without supervision, labeled training data for automated language identification for social media, micro-blogging, and other uses. Apparatus 500 may interact with other apparatus, processes, and services through, for example, a computer network.

The set 530 of logics may include a first logic 532 that is configured to produce a predicted language classification for a post to a micro-blog (e.g., Twitter), social media (e.g., Facebook), or other services. A micro-blog may be characterized by short messages (e.g., less than 140 characters) that include colloquialisms, emoticons, hash tags, and new combinations of characters that convey meaning (e.g., LOL, OMG, XD>>>). In one embodiment, posts in the micro-blog or social media site may be limited to short lengths (e.g., being less than one hundred characters). The first logic 532 is configured to produce the predicted language classification without using a base language classifier. The predicted language classification is produced from information other than the message in the post itself. For example, the predicted language classification may depend, at least in part, on geographic data associated with the post. The geographic data may be, for example, a country code provided with a Tweet, a GPS co-ordinate provided with a message from a mobile device, a latitude/longitude identifier provided with the post, or other geographic information. The geographic information may be precise (e.g., to within one meter) or may be approximate (e.g., to within a city, a state, a province, a region, a country).

The set 530 of logics may also include a second logic 534 that is configured to produce an actual language classification for the post. The actual language classification is produced by the base language classifier. The actual language classification is produced without reference to the geographic data. Thus, two separate approaches are used to produce two separate classifications for a post. If the two separate classifications do not match, then the post may have been too difficult for the classifier to accurately classify at this time or the information (e.g., geographic information) may have provided an inaccurate clue concerning the language of the post, or some other factors may have been involved. Regardless of the reason why the mismatch occurred, the post may not be added to a set of labeled training data that is being grown by apparatus 500.

The set 530 of logics may also include a third logic 536 that is configured to selectively add the post and a language label for the post to the set of labeled training data upon determining that the predicted language classification matches the actual language classification. Thus, posts for which there are matching language classifications from different classifiers may be added to the labeled training data that is being grown by apparatus 500. The labeled training data is electronic data stored in a data store. The labeled training data cannot be read, written, or otherwise processed without the use of a computer apparatus.

In different embodiments, some processing may be performed on the apparatus 500 and some processing may be performed by an external service or apparatus. Thus, in one embodiment, apparatus 500 may also include a communication circuit that is configured to communicate with an external source. In one embodiment, the third logic 536 may interact with a presentation service 560 to facilitate displaying data using different presentations for different devices. For example, information describing language classifications for posts to a social media site may be presented to users.

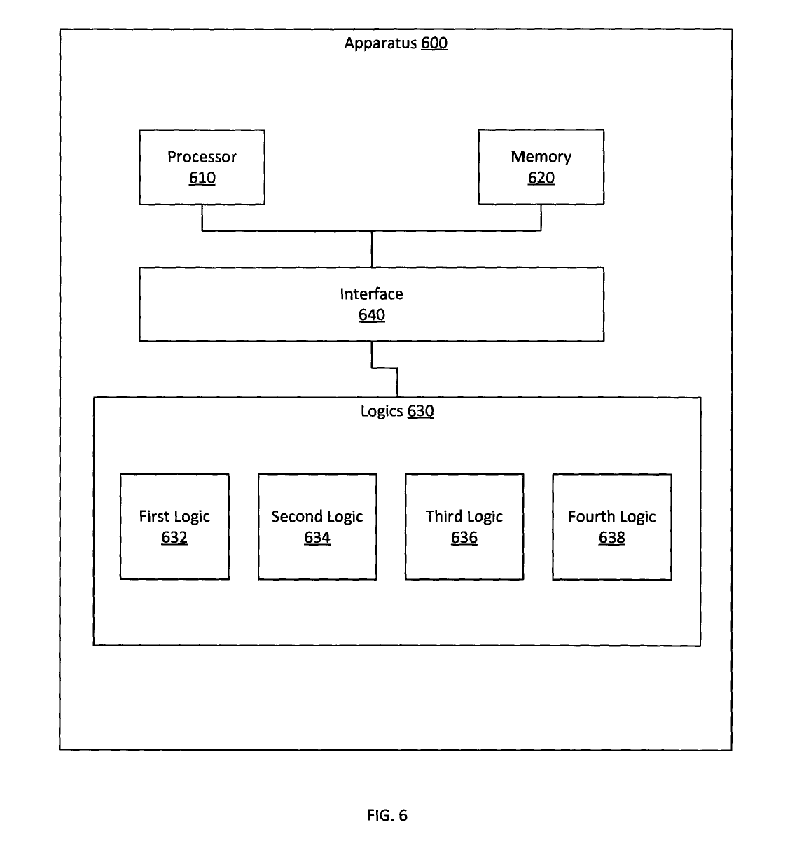

FIG. 6 illustrates an apparatus 600 that is similar to apparatus 500 (FIG. 5). For example, apparatus 600 includes a processor 610, a memory 620, a set of logics 630 (e.g., 632, 634, 636) that correspond to the set of logics 530 (FIG. 5) and an interface 640. However, apparatus 600 includes an additional fourth logic 638. The fourth logic 638 may be configured to perform additional processing.

For example, fourth logic 638 may be configured to assemble a set of base language documents from online, publicly available, labeled documents having user-generated content. In one embodiment, the base language documents may be taken from Wikipedia. The documents are “labeled” in that the language in which they are written is known. Assembling the set of base language documents may include, for example, copying documents into a data store, acquiring pointers to a set of documents, copying selected portions of documents into a data store, acquiring links to a set of documents, or other actions by which computers can access electronic data.

The fourth logic 638 may be configured to derive a plurality of base language models from the set of base language documents. In one embodiment, two or more base language models may be derived from the set of base language documents. In another embodiment, ten or more base language models may be derived from the set of base language documents. In another embodiment, fifty or more base language models may be derived from the set of base language documents. In yet another embodiment, one hundred or more base language models may be derived from the set of base language documents. In one embodiment, the number of base language models to be derived may be provided by a user of apparatus 600. In another embodiment, the number of base language models may be determined dynamically as a function of the information found in the set of base language documents. For example, a sufficient number of documents may be needed to establish a valid language model. Those skilled in the art of automated computer-based language identification will appreciate that various language models (e.g., statistical classifier based language profiles) may be employed.

In one embodiment, the fourth logic 638 may also be configured to train, as part of deriving a model, the base language classifier to identify the language of posts to the micro-blog, social media site, or other service. While deriving the model and training the classifier are described as separate acts, in one embodiment training a classifier may be part of deriving a model. The posts may be taken from training data, from specially crafted data, from live data, or from other sources. In one embodiment, the base language classifier may be trained until the base language classifier can produce a first desired accuracy. In an attempt to achieve the first desired accuracy, which may not occur, the base language identifier may need to be trained with initial data and then retrained with subsequent data.

In one embodiment, the fourth logic 638 may be configured to derive a plurality of target language models from the labeled training data. The plurality of target language models may include the same or a different number of base language models than were derived. The plurality of target language models may include two or more models, ten or more models, one hundred or more models, or different numbers of models. In one embodiment, the number of models may be controlled by a user input while in another embodiment the number of models may be controlled by the information content of the labeled training data. For example, labeled training data sufficient to characterize Y different languages may be available (Y being an integer). A user may decide to have Y-X (X being an integer) target language models derived or fourth logic 638 may control the deriving of Y-M (M being an integer) target language models.

As part of deriving a target language model, the fourth logic 638 may train a target language classifier. The target language classifier will be trained to identify the language of posts to the micro-blog or social media site. For example, the target language classifier may be trained to identify the language in which a Tweet was written, to identify the language in which a Facebook post was written, or to identify the language of other posts. In one embodiment, the target language classifier may be trained to be able to identify the language of posts with an accuracy greater than the accuracy of the base language classifier. One skilled in the art will appreciate that different classifiers may employ different models. For example a statistical classifier may rely on language profiles while a vector based classifier may rely on a different language model.

In one embodiment, the fourth logic 638 may be configured to selectively control the apparatus 600 to produce and store additional labeled training data for automated language identification. For example, a first set of labeled training data may be produced at a first time. The first set of labeled training data may be used for a first period of time or until a first event occurs. For example, the first set of labeled training data may be used for an hour, a day, a week, a month, or other pre-defined period of time. In another example, the first set of labeled training data may be used until an event occurs. Events may include, for example, changes to languages for which models were built, having processed a threshold number of posts, having reached an accuracy threshold, or other events. Changes to languages may occur, for example, by the addition of new words to a language. For example, in Twitter, new hash tags are frequently invented. These hash tags may provide information from which a language determination may be made. Therefore, the addition of a threshold number of hash tags may lead to the fourth logic 638 selectively controlling the apparatus 600 to produce and store additional labeled training data.

As part of deriving a target language model, the fourth logic 638 may train a new target language classifier. The new target language classifier may be trained as a function of the additional labeled training data. In one embodiment, the new target language classifier may be trained until a desired accuracy for the new target classifier is satisfied or until a threshold number of attempts to achieve the desired accuracy have been tried or until another training threshold has been met. In one embodiment, the additional labeled training data may be produced after substituting the target language classifier for the base language classifier. This substitution and retraining may iterate until a desired accuracy is achieved.

In one embodiment, the fourth logic 638 may be configured to selectively control the apparatus 600 to produce and store new labeled training data upon determining that an update threshold has been met. The update threshold may be associated with a change to one of the languages associated with the plurality of base language models. For example, a new token (e.g., hash tag, combinations of characters) may be added to the language. The update threshold may also concern a dynamic time period (e.g., how long the labeled training data has been used), or a set time period (e.g., one week). The update threshold may also concern the amount of traffic being processed, for example a number of posts classified by the target language classifier.

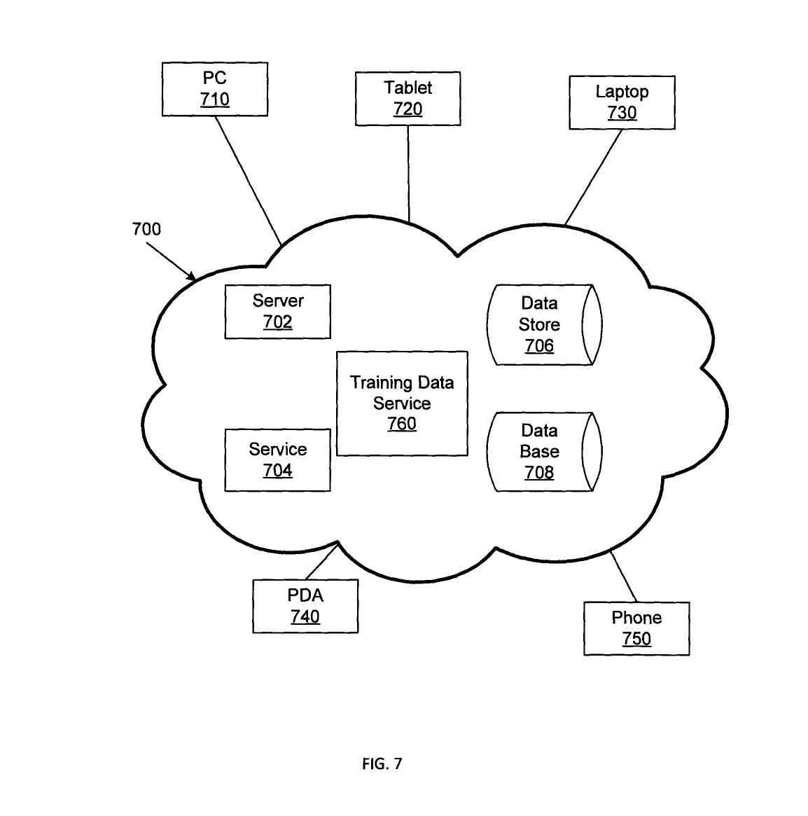

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example training data service 760 residing in the cloud. The training data service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the training data service 760.

FIG. 7 illustrates various devices accessing the training data service 760 in the cloud. The devices include a computer 710, a tablet 720, a laptop computer 730, a personal digital assistant 740, and a mobile device (e.g., cellular phone, satellite phone, wearable computing device) 750. The training data service 760 may produce training data for automated language identifiers. The training data for automated language identifiers may be used to build language models, to train language classifiers, or for other purposes.

It is possible that different users at different locations using different devices may access the training data service 760 through different networks or interfaces. In one example, the training data service 760 may be accessed by a mobile device 750. In another example, portions of training data service 760 may reside on a mobile device 750.

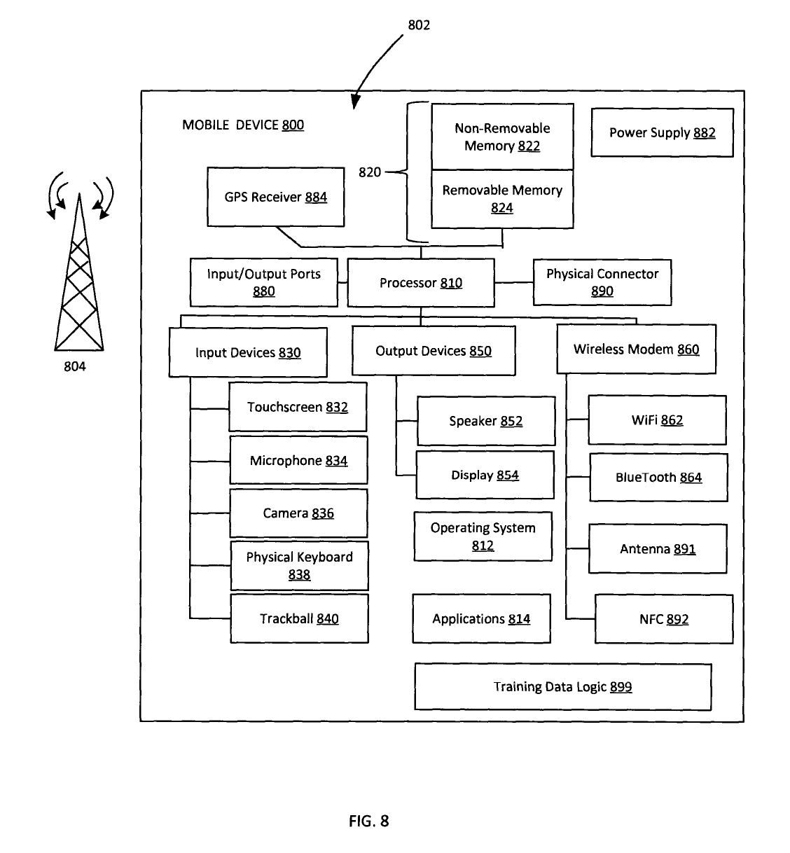

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), wearable computing device, etc.) and may allow wireless two-way communications with one or more mobile communications networks 804, such as a cellular or satellite networks.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), video games, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include tweets, posts, game clips, web pages, text, images, sound files, video data, or other data sets to be sent to or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting gestures to provide input to a gaming application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). NFC 892 facilitates having near field communications (NFC).

The mobile device 800 may include at least one input/output port 880, a power supply 882, a satellite navigation system receiver 884, such as a Global Positioning System (GPS) receiver, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include training data logic 899 that is configured to provide a functionality for the mobile device 800. For example, training data logic 899 may provide a client for interacting with a service (e.g., service 760, FIG. 7). Portions of the example methods described herein may be performed by training data logic 899. Similarly, training data logic 899 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store electronic data. A data store may be, for example, a database, a table, a file, a list, a queue, a heap, a memory, a register, and other physical repository. In different examples, a data store may reside in one logical or physical entity or may be distributed between two or more logical or physical entities. Storing electronic data in a data store causes a physical transformation of the data store.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
accessing a target corpus of electronic communications associated with an electronic communication service;
identifying a member of the target corpus that includes an attribute from which a predicted classification of the member can be made, the attribute being separate from a message portion of the member;
accessing the predicted classification of the member, where the predicted classification is a function of the attribute and where the predicted classification is made without reference to a base classifier;
accessing an actual classification of the member, where the actual classification is made by the base classifier, the base classifier being configured to classify communications associated with the electronic communication service; and
upon determining that the predicted classification matches the actual classification:
adding a labeled member to a target training corpus stored in a data store, the labeled member comprising the member and data representing the actual classification.

2. The method of claim 1, where the electronic communication service is an online social networking service or micro-blogging service.

3. The method of claim 1, where the communications in the target corpus are characterized by non-standard spellings, by non-standard spellings intended to convey emphasis, by the use of vernacular expressions, or by a length shorter than a threshold length.

4. The method of claim 1, where the attribute from which the predicted classification of the member can be made comprises geographic information.

5. The method of claim 1, where the predicted classification and the actual classification concern a language in which the member is written.

6. The method of claim 1, where the predicted classification and the actual classification concern a demographic associated with a writer of the member.

7. The method of claim 1, where the base classifier is a statistical language classifier that relies on base language models built from a base corpus of labeled documents.

8. The method of claim 7, comprising building the base corpus of labeled documents from a publicly available online source that includes labeled user-generated content.

9. The method of claim 8, comprising:
upon determining that the target training corpus is sufficient for training a target classifier in target training models derived from the target training corpus, where the target classifier is to classify communications associated with the electronic communication service:
deriving the target training models using the target training corpus, and
storing the target training models in the data store.

10. The method of claim 9, comprising controlling the target classifier to classify an electronic communication associated with the electronic communication service.

11. The method of claim 10, the base classifier being configured to classify electronic communications from the electronic communication service as belonging to one of at least fifty different languages with an accuracy of at least ninety percent, the target classifier being configured to classify communications from the electronic communication service as belonging to one of the at least fifty different languages with an accuracy of at least ninety-five percent.

12. The method of claim 1, comprising selectively updating the target training corpus or the target training models upon detecting an update event, the update event being a change in a language in which communications can be written in the electronic communication service, the appearance of a new hash tag in a language in which communications can be written in the electronic communication service, the passage of a threshold amount of time, or the processing of a threshold number of members of the target corpus.

13. A computer-readable storage medium storing computer-executable instructions that when executed by a computer control the computer to perform a method, the method comprising:
constructing a base language corpus from a publicly available source of labeled documents that include user-generated content;
deriving base language models for a plurality of languages from the base language corpus, where the base language models include base language classifiers configured to be able to identify documents from a communication service in the plurality of languages;
identifying a possible classification of a document in a target language corpus, where the possible classification is a function of supporting evidence associated with the document, and where the possible classification does not rely on a base language classifier, where the target language corpus comprises documents from the communication service;
producing an actual classification of the document, where the actual classification relies on a base language classifier;
upon determining that the actual classification does not match the possible classification, discarding the document;
upon determining that the actual classification does match the possible classification, adding the document and a label for the document to a filtered language corpus; and
upon determining that the filtered language corpus has reached a threshold size:
deriving target language models for the plurality of languages from the filtered language corpus, where the target language models include target language classifiers configured to identify documents from the target corpus in the plurality of languages.

14. The computer-readable storage medium of claim 13, the method comprising:
iterating, until a termination condition is reached:
establishing the base language classifier for an iteration I+1 as the target language classifier of iteration I, I being an integer greater than zero;
establishing the base language corpus for iteration I+1 as the filtered language corpus of iteration I;
rebuilding a filtered language corpus for iteration I+1; and
rebuilding the target language classifier for iteration I+1.

15. The computer-readable storage medium of claim 14, the termination condition being reaching a threshold number of iterations, spending a threshold amount of time training, reaching a desired accuracy, or detecting a lower than desired rate of convergence in classifier accuracy.

16. An apparatus configured to automatically produce and store, without supervision, labeled training data for automated language identification, comprising:
a processor;
a memory;
a set of logics configured to produce the labeled training data; and
an interface to connect the processor, the memory, and the set of logics;
the set of logics comprising:
a first logic configured to produce a predicted language classification for a post to a micro-blog or social media site, the post being less than a threshold number of characters, where the predicted language classification is produced without using a base language classifier and where the predicted language classification depends, at least in part, on supporting evidence associated with the post;
a second logic configured to produce an actual language classification for the post, where the actual language classification is produced by the base language classifier without reference to the supporting evidence; and
a third logic configured to selectively add the post and a language label for the post to the labeled training data upon determining that the predicted language classification matches the actual language classification, the labeled training data being electronic data stored in a data store.

17. The apparatus of claim 16, comprising a fourth logic configured to:
assemble a set of base language documents from online, publicly available labeled documents having user-generated content; and
derive a plurality of base language models from the set of base language documents, where the base language models include base language classifiers configured to identify, with a first accuracy, the language of posts to the micro-blog or social media site.

18. The apparatus of claim 17, the fourth logic being configured to:
derive a plurality of target language models from the labeled training data, where a target language model includes a target language classifier configured to identify, with a second accuracy greater than the first accuracy, the language of posts to the micro-blog or social media site.

19. The apparatus of claim 18, the fourth logic being configured:
to selectively control the apparatus to produce and store additional labeled training data for automated language identification and to derive a new target language model as a function of the additional labeled training data until a training termination condition for the new target language model is satisfied, where the additional labeled training data is produced after substituting the target language classifier for the base language classifier; and
to selectively control the apparatus to produce and store new labeled training data upon determining that an update threshold has been met, the update threshold being associated with a change to one of the languages associated with the plurality of base language models, a time period, or a number of posts classified by the target language classifier.

20. The apparatus of claim 16, where the supporting evidence is geographic data associated with the post or profile information associated with the author of the post.
